(19) United States
(12) Patent Application Publication
(10) Pub. No.: US 2016/0246439 A1
(43) Pub. Date: Aug. 25, 2016

(54) Derivative Integration Event Detection For Digital Data Stream Such As For Touch-on-Metal Detection

(71) Applicant: TEXAS INSTRUMENTS INCORPORATED, Dallas, TX (US)

(72) Inventor: Evgeny Fomin, San Carlos, CA (US)

(21) Appl. No.: 15/050,459

(22) Filed: Feb. 22, 2016

Related U.S. Application Data
(60) Provisional application No. 62/119,144, filed on Feb. 21, 2015.

(51) Int. Cl. G06F 3/041

(52) U.S. Cl. CPC G06F 3/0416

(57) ABSTRACT

An event detection methodology is suitable for detecting an event in a continuous digital data stream, such as a ToM (touch on metal) button press. The methodology includes acquiring successive derivative data samples, and, for each derivative data sample, evaluating if the derivative data sample meets a derivative event rejection condition: if no, evaluating the next derivative data sample; or if yes, performing derivative integration accumulation, and evaluating if the derivative integration accumulation meets an integration event condition. If yes, signal event detection, or if no, evaluate the next derivative data sample and the next derivative integration accumulation. The methodology can further include dissipating the derivative integration accumulation by a leakage factor. The derivative event rejection condition can be a derivative interval, such as ABS D[i]>T_D, where T_D is a derivative event rejection threshold, or TD_L≦ABS D[i]<TD_H, where TD_L and TD_H correspond to a derivative interval. The integration event condition can be ABS I[i]>ABS [T_I], where T_I is an integration event threshold.

### CROSS-REFERENCE TO RELATED APPLICATIONS

Priority is claimed under 37 CFR 1.78 and 35 USC 119(e) to US Provisional Application 62/119,144 (Docket TI-75788PS), filed 2015 Feb. 21), which is incorporated by reference.

### BACKGROUND

### Technical Field

This Patent Disclosure relates generally to touch on metal event detection, and even more generally to a methodology for event detection for which touch on metal is one application.

Touch-on-metal (also referred to as touch-through-metal) systems (ToM), such as ToM key pads, are subject to changes in baseline operating conditions (such as temperature or noise), or mechanical conditions (such as deformations), all of which can generally be referred to as changes in baseline conditions or drift. Such changes in baseline conditions or drift can affect event detection (such as button press), resulting in false event detection.

While this Background information references ToM detection, the Disclosure in this Patent Document is more generally directed to derivative-based event detection for digital data stream.

### BRIEF SUMMARY

This Brief Summary is provided as a general introduction to the Disclosure provided by the Detailed Description and Drawings, summarizing aspects and features of the Disclosure. It is not a complete overview of the Disclosure, and should not be interpreted as identifying key elements or features of, or otherwise characterizing or delimiting the scope of, the disclosed invention.

The Disclosure describes a methodology for derivative integration event detection for digital data stream, such as can be used for touch-on-metal (ToM) detection, including derivative sample evaluation and integration accumulation for event detection, and including optional use of a leakage factor in the “no event” path to dissipate derivative integration accumulation due to changes in baseline conditions (drift), which can cause a false event detection

According to aspects of the Disclosure, the event detection methodology is suitable for detecting an event in a continuous digital data stream, such as a ToM (touch on metal) button press. The methodology can include acquiring successive derivative data samples, and, for each derivative data sample, evaluating if the derivative data sample meets a derivative event rejection condition: if no, evaluating the next derivative data sample; or if yes, performing derivative integration accumulation, and evaluating if the derivative integration accumulation meets an integration event condition. If yes, signal event detection, or if no, evaluate the next derivative data sample and the next derivative integration accumulation. The methodology can further include dissipating the derivative integration accumulation by a leakage factor. The derivative event rejection condition can be a derivative interval, such as ABS D[i]>T_D, where T_D is a derivative event rejection threshold, or TD_L≦ABS D[i]<TD_H, where TD_L and TD_H correspond to a derivative interval. The integration event condition can be ABS I[i]>ABS [T_I], where T_I is an integration event threshold.

Other aspects and features of the invention claimed in this Patent Document will be apparent to those skilled in the art from the following Disclosure.

### BRIEF DESCRIPTION OF THE DRAWINGS

FIG. 1 is a flow diagram of an example embodiment of the methodology for derivative integration event detection for digital data stream, such as can be used for touch-on-metal (ToM) detection, including derivative sample evaluation and integration accumulation for event detection, and including optional use of a leakage factor in the “no event” path to dissipate derivative integration accumulation due to changes in baseline conditions (drift), which can cause a false event detection.

FIG. 2 is a flow diagram of an alternate example embodiment of the methodology for derivative integration event detection for digital data stream, including optional use of a leakage factor correction in both the “event-detect” and “no-event” paths to dissipate derivative integration accumulation, and correct for accumulated error due to changes in baseline conditions or drift.

FIG. 3 is a flow diagram of an alternate example embodiment of the methodology for derivative integration event detection for digital data stream, including derivative sample evaluation for both drift (changes in baseline operational and mechanical conditions), and noise spikes (such as caused by extraordinary mechanical deformations) based on “ABS [TD_L]≦ABS D[i]<ABS [TD_H]”, where TD_L and TD_H are respectively low and high derivative thresholds.

FIG. 4 is an example plot illustrating event detection according to the methodology for derivative integration event detection for digital data stream, including data, derivative and integration plots.

### DETAILED DESCRIPTION

This Description and the Drawings constitute a Disclosure for derivative integration event detection for digital data stream (including derivative sample evaluation and integration accumulation for event detection), including example embodiments that illustrate various technical features and advantages. In an example application, the Disclosed methodology for derivative integration event detection for digital data stream can be used for touch-on-metal detection.

In brief overview an event detection methodology is suitable for detecting an event in a continuous digital data stream, such as a ToM (touch on metal) button press. The methodology includes acquiring successive derivative data samples, and, for each derivative data sample, evaluating if the derivative data sample meets a derivative event rejection condition: if no, evaluating the next derivative data sample; or if yes, performing derivative integration accumulation, and evaluating if the derivative integration accumulation meets an integration event condition. If yes, signal event detection, or if no, evaluate the next derivative data sample and the next derivative integration accumulation. The methodology can further include dissipating the derivative integration accumulation by a leakage factor. The derivative event rejection condition can be a derivative interval, such as ABS D[i]>T_D, where T_D is a derivative event rejection threshold, or TD_L≦ABS D[i]<TD_H, where TD_L and TD_H correspond to a derivative interval. The integration event condition can be ABS I[i]>ABS [T_I], where T_I is an integration event threshold.

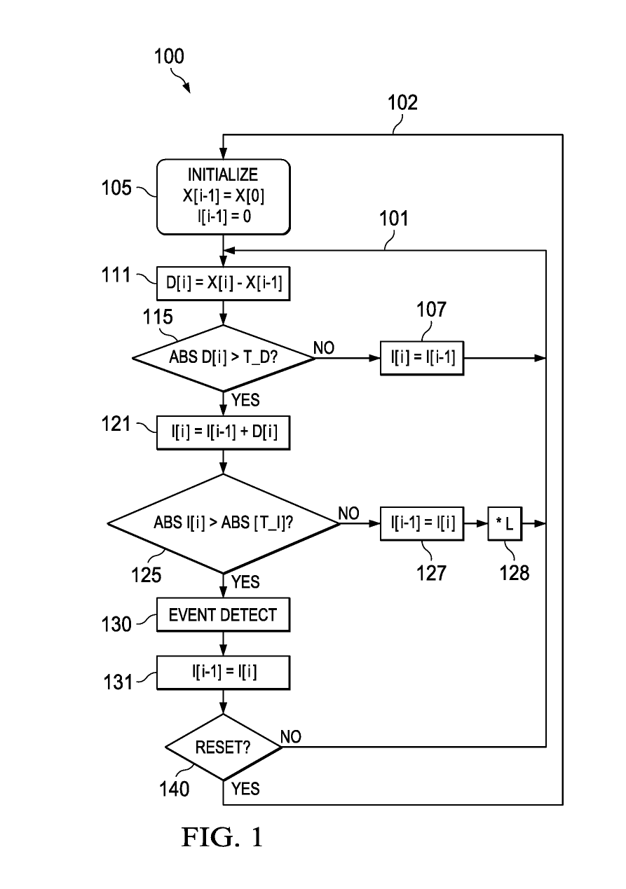

FIGS. 1-3 illustrate alternate example methodologies for derivative integration event detection for digital data stream according to this Disclosure. In each case, the example methodology is described for a single channel data stream, with the understanding that the Disclosed methodology can be extended to multi-channel operation. The example event detection methodologies are described in the context of an example application of detecting touch-on-metal (ToM) button presses.

FIG. 1 is a flow diagram of an example embodiment of the methodology for derivative integration event detection for digital data stream 100, including derivative sample evaluation and integration accumulation for event detection, and including optional use of leakage factor correction in the “no event” path to dissipate derivative integration accumulation due to drift (changes in baseline conditions).

The example methodology for event detection using derivative integration 100 is described with reference to the following parameters:

User parameters

| | |
|---|---|
| Derivative_Event_Rejection Threshold | T_D |
| Integration_Event Threshold | T_I |
| Leakage factor (optional) | L |
| Decimation factor | N |

Other parameters

| | |
|---|---|
| Digital Data In (samples) | X[i] current data, |
| | X[i−1] previous data |
| Derivative | D[i] |
| Derivative Integration | I[i], I[i−1] |

An example derivative integration methodology 100 is described in the context of a ToM system designed for ToM button press detection. Derivative integration methodology 100 includes two loops: and event-detection loop 101 and a reset loop 102.

The ToM system is initialized 105 by processing derivative data point (X[0]), and setting derivative integration=0: X[i−1]=X[0]; I[i−1]=0.

The derivative integration methodology proceeds to the event-detection loop 105, by processing 111 every Nth Derivative data point (X[N], X[2N] . . . : D[i]=X[i]−X[i−1]) (decimation factor), to determine 115 whether a derivative condition is met, a derivative evaluation condition defined according to this Disclosure.

For the example embodiment, the derivative evaluation condition 115 is ABS(D[i])>T_D (the derivative event rejection threshold):

True: I[i]=I[i−1]+D[i] Derivative Data Accumulation 121

Else: I[i]=I[i−1] No Accumulation 117 and loop back

Note that the absolute value of the derivative sample (D[i]) is evaluated against the T_D derivative event rejection threshold, as the derivative may be increasing or decreasing relative to the threshold. The T_D derivative event rejection threshold can be used to establish a rejection threshold for derivative changes caused by changes in operating or other baseline conditions.

If ABS(D[i]) is greater than the T_D event rejection threshold, then the event-detection loop 101 proceeds to event detection evaluation based on derivative integration accumulation 121, and event-detection evaluation based on derivative integration 125. The derivative sample is accumulated 121 (I[i]=I[i−1]+D[i]), and used to evaluate whether event detection has occurred (for example, ToM button press) based in a derivative integration condition defined according to this Disclosure.

For the example embodiment, the derivative integration condition 125 is ABS I[i]>ABS [T_I]. The derivative sample is accumulated I[i]=I[i−1]+D[i], and derivative integration is evaluated based on whether ABS I[i]>ABS [T_I]:

| | |
|---|---|
| True: | Output Press_detect 130 |
| | I[i−1] = I[i] 131 |
| Else: | Press not detected |
| | I[i−1] = I[i] [*L] 127/128 |

Note that the absolute value of the derivative integration accumulation (ABS I[i]) is evaluated against the absolute value of the integration_event threshold (ABS [T_I]). As described below, this procedure generalizes the derivative integration methodology for both peak and valley event detection.

That is, if an event condition (such as ToM press_detect) is detected 130, an event condition can be signaled, and the loopback integration accumulation I[i−1] is set to I[i] 131. Ignoring extraneous accumulation considerations resulting from changes in baseline conditions (drift, noise, mechanical deformation), after integration accumulation of derivative samples exceeds the integration_event threshold, derivative samples will eventually turn negative, and reduce the integration accumulation (I[i−1]=I[i]) to baseline.

As illustrated, for the example derivative integration event detection methodology 100, the event detection loop 101 can include the optional use of a leakage factor in the “no event” path to dissipate derivative integration accumulation due to drift, and prevent accumulated drift from causing a false event detection.

If derivative accumulation evaluation 125 (ABS I[i]>ABS [T_I]) indicates that the integration_event threshold is not exceeded (absolute value), then the event detection loop 101 loops back by setting I[i−1]=I[i] 127. Leakage dissipation of derivative integration accumulation due to drift is represented by introducing a leakage factor [*L] factor 128 into the loop to slowly dissipate accumulated derivative integration to correct for accumulated error. For example, the rate of dissipation can be programmable from L=0 (instant dissipation) to L=1(no dissipation), with a typically value being close to but less than one (such as, based on LSB subtraction/truncation).

Leakage correction prevents derivative integration accumulation due to drift from indicating a false event detection by slowly reducing Integration accumulation back to baseline (in the absence of derivative data accumulation indicating an event). That is, if the derivative integration accumulation evaluation 121 (I[i]=I[i−1]+D[i]) does not accumulate to the integration_event detection threshold [T_I] (absolute value) as determined by evaluation 125, then the loop back accumulated integration I[i−1]=I[i] is reduced by the leakage factor L (I[i−1]=I[i]*L) 127/128.

Note that leakage correction can be configured to operate until an integration_event threshold is exceeded in absolution value ABS I[i]>ABS [T_I]. Such a configuration is advantageous for peak/valley detection described below.

If derivative integration event detection in 125 (ABS I[i]>ABS [T_I]) indicates an event condition 130, a reset condition is tested 140. If reset is not signaled, then the then the loopback I[i−1] is set to I[i] 131, and the event detection loop 101 proceeds with another derivative integration accumulation and evaluation.

If reset is signaled, then the reset loop 102 operates to re-initialize 105 the event detection loop 101. The example reset function (such as an SPI command), can be used, for example, to account for unforeseen events, like a stuck button.

The derivative integration event detection methodology is configurable for both peak and valley event detection, such as for ToM up/dn auto window switch detection. Each peak/valley can be defined by two threshold crossings (and the derivative data between them) enabling peak/valley processing.

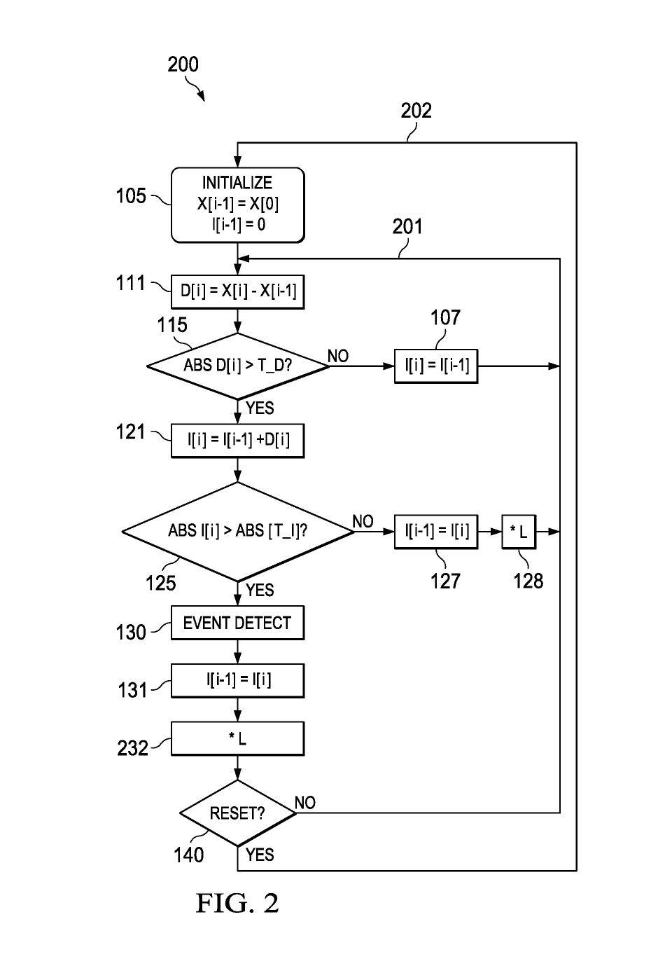

FIG. 2 is a flow diagram of an alternate example embodiment of the methodology for derivative integration event detection for digital data stream, including optional use of leakage factor dissipation in both the “event-detect” and “no-event” paths after derivative integration accumulation evaluation. That is, event detection loop 201 operates to dissipate derivative integration accumulation that can be caused by changes in baseline conditions (such as drift, noise or mechanical deformations), in each pass through the event detection loop, after derivative integration accumulation evaluation 125.

As in the embodiment of FIG. 1, derivative integration accumulation evaluation 125 in event detection loop 201 evaluates the derivative integration condition (ABS I[i]>ABS [T_I]). For a no_event condition, (I[i]=I[i−1]+D[i]) does not accumulate to the integration_event detection threshold [T_I], and the loop back accumulated integration I[i−1]=I[i] is reduced by the leakage factor L (I[i−1]=I[i]*L) 127/128. For an event-detection condition, in which (I[i]=I[i−1]+D[i]) accumulates to the integration_event detection threshold [T_I], and event detect condition is signaled 131, and the accumulated integration I[i−1]=I[i] is also reduced by the leakage factor L (I[i−1]=I[i]*L) 131/232.

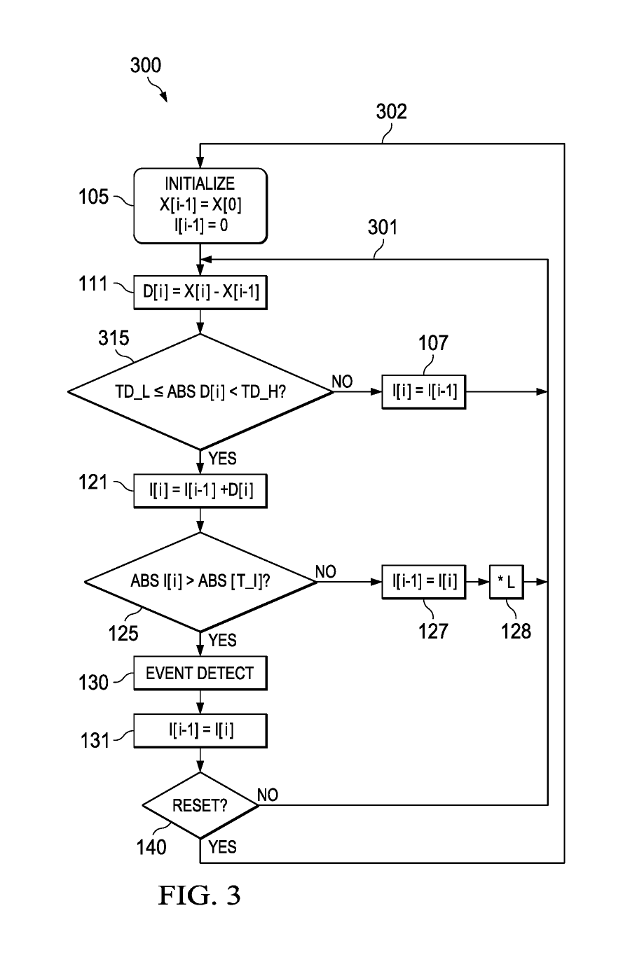

FIG. 3 is a flow diagram of an alternate example embodiment of the methodology for derivative integration event detection for digital data stream, including derivative sample evaluation 315 for both changes in baseline derivative conditions (drift), and abrupt changes in derivative conditions such as noise spikes. For this embodiment, derivative samples D[i] are evaluated 305 based on a derivative condition “ABS [TD_L]≦ABS D[i]<ABS [TD_H]”, where TD_L and TD_H are low and high derivative thresholds (such as for drift and noise spikes). That is, according to this alternate embodiment, protection against noise spikes or other abrupt changes can be implemented with a threshold range, including, for example, ignoring derivatives exceeding a threshold TD_H, in addition to rejecting derivative changes resulting from changes in baseline condition, rejected by the derivative noise rejection threshold TD_L.

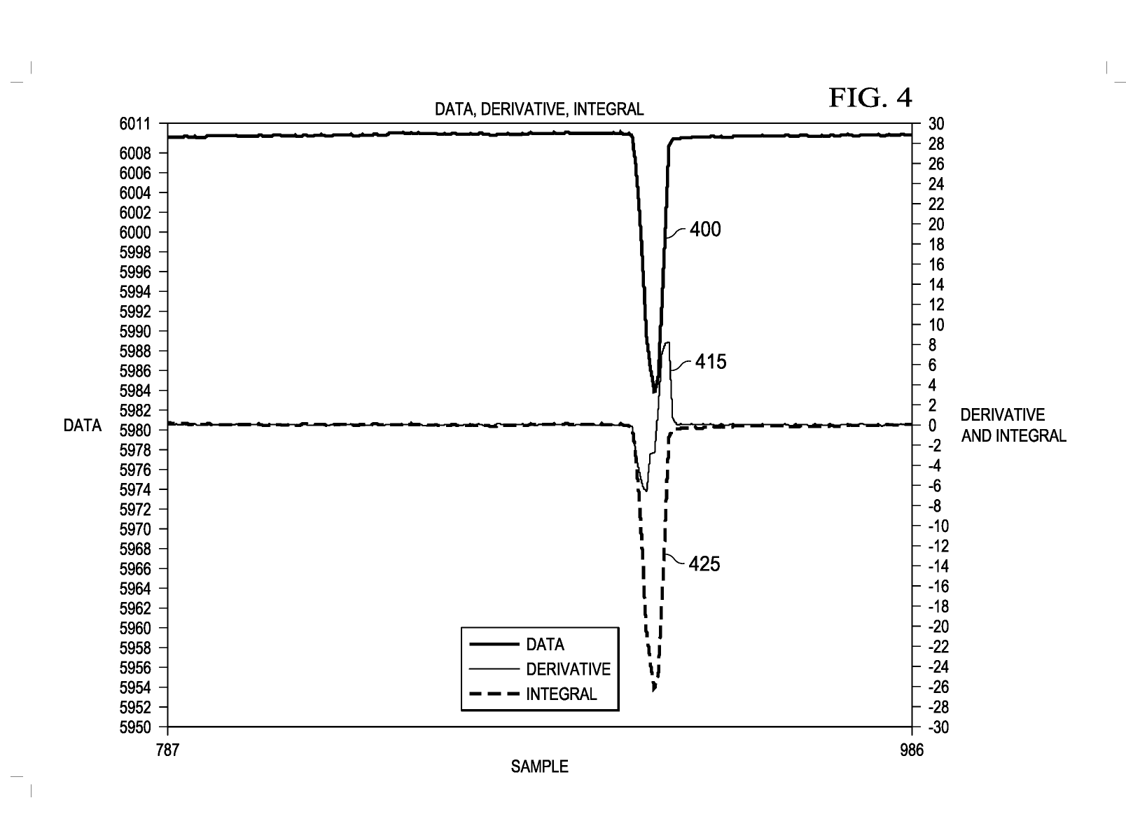

FIG. 4 is an example plot illustrating event detection according to the methodology for derivative integration event detection for digital data stream, including plots for data 400, derivative 415 and integration 425 plots.

The Disclosure provided by this Description and the Figures sets forth example embodiments and applications illustrating aspects and features of the invention, and does not limit the scope of the invention, which is defined by the claims. Known circuits, functions and operations are not described in detail to avoid obscuring the principles and features of the invention. These example embodiments and applications can be used by ordinarily skilled artisans as a basis for modifications, substitutions and alternatives to construct other embodiments, including adaptations for other applications.

1. An event detection method suitable for detecting an event in a continuous digital data stream, comprising:
acquiring successive derivative data samples;
for each derivative data sample, evaluating if the derivative data sample meets a derivative event rejection condition;
if no, evaluating the next derivative data sample if yes,
performing derivative integration accumulation; and
evaluating if the derivative integration accumulation meets an integration event condition
if yes, signal event detection
if no, evaluate the next derivative data sample and the next derivative integration accumulation.

2. The method of claim 1, wherein the event detection method is adapted for touch-on-metal (ToM) event detection.

3. The method of claim 1, wherein the derivative event rejection condition corresponds to a derivative interval.

4. The method of claim 1, further comprising, at least after evaluating that the integration event condition is not met, dissipating the derivative integration accumulation by a leakage factor.

5. The method of claim 1, wherein the derivative event rejection condition is: ABS D[i]>T_D, where T_D is a derivative event rejection threshold.

6. The method of claim 1, wherein the derivative event rejection condition is: TD_L≦ABS D[i]<TD_H, where TD_L and TD_H correspond to a derivative interval.

7. The method of claim 1, wherein the integration event condition is: ABS I[i]>ABS [T_I], where T_I is an integration event threshold.
